(19) United States
(12) Patent Application Publication
(10) Pub. No.: US 2020/0126117 A1
(43) Pub. Date: Apr. 23, 2020

(54) SYSTEMS AND METHODS FOR TRIGGERING MARKETING OPERATIONS

(71) Applicant: Clarivoy, Inc., Columbus, OH (US)

(72) Inventors: Steve White, Granville, OH (US); PETER QUINONES, Miami, FL (US)

(21) Appl. No.: 16/658,672

(22) Filed: Oct. 21, 2019

Related U.S. Application Data
(60) Provisional application No. 62/748,502, filed on Oct. 21, 2018.

(51) Int. Cl. G06Q 30/02; G06F 16/9535

(52) U.S. Cl. CPC G06Q 30/0251; G06F 16/9535

(57) ABSTRACT

The subject disclosure relates to detecting lead data representing any one or more of a range of leads and transmitting notification data to a data store based on detection of the lead data. In an example, a computer program product is disclosed that comprises a computer readable storage medium having program instructions embodied therewith, the program instructions executable by a processor to cause the processor to detect first data representing a type of lead, from one or more first data store based on lead criteria data. The computer program product also causes the processor to determine whether a subset of first data matches second data representing existing customer information.

### CROSS REFERENCE TO RELATED APPLICATION

This application claims priority to and claims the benefit of priority to U.S. Application No. 62/748,502, filed on Oct. 21, 2018, and entitled “METHODS FOR IDENTIFYING AND TRANSFORMING LEAD DATA”. The entirety of the disclosure of the aforementioned application is considered part of, and is incorporated by reference in, the disclosure of this application.

### BACKGROUND

There are several challenges automotive dealerships face related to digital and physical customer interactions. As a result, such dealerships face several difficulties in capturing leads and understanding the potential of each lead to make a purchase. Traditionally, automotive dealership organizations conduct marketing efforts via brute force bulk marketing blasts. As such, the marketing efforts lack knowledge and information about customers which result in such organizations incurring excessive expenditures on marketing efforts. Furthermore, such marketing efforts are also unwanted and unappreciated by customers such that many customers can lose confidence in a product, process or dealer and choose not to explore purchasing a vehicle.

Also, many potential customers who may be great leads for dealerships to contact may not directly contact the dealership via traditional methods (e.g., website form fill, direct phone call, etc.) out of fear of being overly offered sales or sold to by the dealership or a fear of being inundated with marketing materials. In another aspect, potential dealership customers have access to much research information via public means such as dealership websites, online automotive resources and a plethora of other available information such that many potential customers refrain from directly contacting a dealership. Another challenge in dealership accesses and assessing leads are that the prolific use of mobile devices for conducting shopping activities has cut into consumers completing lead submission forms. As such, many mobile users refrain from submitting information to automotive dealerships despite having an interest in the type of inventory the dealership holds.

Furthermore, given that potential dealership consumers are reticent to avail themselves of their identity (e.g., by completing lead generation forms or participating in lead generation processes), customers whom are in the market to make a vehicle purchase are often kept anonymous and inaccessible to dealerships causing a loss of a potential dealership sale for lack of opportunity to engage with such customers. Accordingly, there are several challenges that automotive dealerships currently face with respect to accessing potential vehicle purchaser leads.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that facilitate detecting data representing one or more lead.

According to an embodiment, a system is provided. The system comprises a processor that executes computer executable components stored in memory. The computer executable components include a detection component that extracts, by a matching server device, first data representing a type of lead, from one or more first data store based on lead criteria data. Furthermore, the computer executable components include a matching component that determines, by the matching server device, determines, by the matching server device, whether a subset of first data matches second data representing existing customer information. In another aspect, the computer executable components can comprise a notification component that transmits, by the matching server device, notification data to a dealer device, the one or more first data store or a one or more second data store based on whether a matching event occurred between the subset of first data and the second data, wherein the one or more first data store is different than the one or more second data store.

According to another embodiment, a computer-implemented method is provided. The computer-implemented method can comprise detecting, by a system operatively coupled to a processor, first data representing a type of lead, from one or more first data store based on lead criteria data. The computer-implemented method can also comprise determining, by the system, whether a subset of first data matches second data representing existing customer information. In another aspect, the computer-implemented method can also comprise transmitting, by the system, notification data to a dealer device, the one or more first data store or a one or more second data store based on whether a matching event occurred between the subset of first data and the second data, wherein the one or more first data store is different than the one or more second data store.

According to yet another embodiment, a computer program product for facilitating a detection of lead data is provided. The computer program product can comprise a computer readable storage medium having program instructions embodied therewith, the program instructions executable by a processor to cause the processor to detect first data representing a type of lead, from one or more first data store based on lead criteria data. The computer program product can also cause the processor to determine whether a subset of first data matches second data representing existing customer information. In another aspect, the computer program product can cause the processor to transmit notification data to a dealer device, the one or more first data store or a one or more second data store based on whether a matching event occurred between the subset of first data and the second data, wherein the one or more first data store is different than the one or more second data store.

### BRIEF DESCRIPTION OF THE DRAWINGS

FIG. 1 illustrates a block diagram of an example, non-limiting system 100 that can facilitate a detection of lead data in accordance with one or more embodiments described herein.

FIG. 2 illustrates a block diagram of an example, non-limiting system 200 that can facilitate an indexing of lead data and an enrichment of lead data with enriched data in accordance with one or more embodiments described herein.

FIG. 3 illustrates a block diagram of an example, non-limiting system 300 that can facilitate an assigning of one or more score to lead data in accordance with one or more embodiments described herein.

FIG. 4 illustrates a flow diagram of an example, non-limiting computer-implemented method 400 that can facilitate a detection of lead data in accordance with one or more embodiments described herein.

FIG. 5 illustrates a flow diagram of an example, non-limiting computer-implemented method 500 that can facilitate an appending of data to customer profile data in accordance with one or more embodiments described herein.

FIG. 6 illustrates a block diagram of an example, non-limiting operating environment 600 in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

The disclosed subject matter includes a system that identifies automotive consumer candidates based on accessing, integrating, and evaluating lead data (representing potential candidates for purchasing a vehicle) from one or more disparate data store(s). In another aspect, the integrated data can be grouped and classified into a respective data category representing a candidate data type (e.g., anonymous lead data with no customer data record, anonymous lead data with an existing customer data record, or self-identified lead data). In another aspect, the system can compare the classified data to existing customer data to determine whether the classified data is associated with existing customer data representing existing known customers of a dealership (e.g., historical data corresponding to a candidate within an automotive vendor intake form, historical vehicle purchase history data, historical browsing data, and other such historical data). Upon a determination that a classified data subset matches existing customer data, such classified or indexed data subset can be transmitted, by the system, to a data store or device that identifies a match occurred between the classified data subset and existing customer data. Furthermore, such classified data can be analyzed (e.g., via machine learning operations) to extract insights (e.g., predicted purchasing insights, marketing insights, etc.) that can trigger executable operations such as marketing operations (e.g., e-mail messaging a candidate, providing discount coupons to a candidate, etc.).

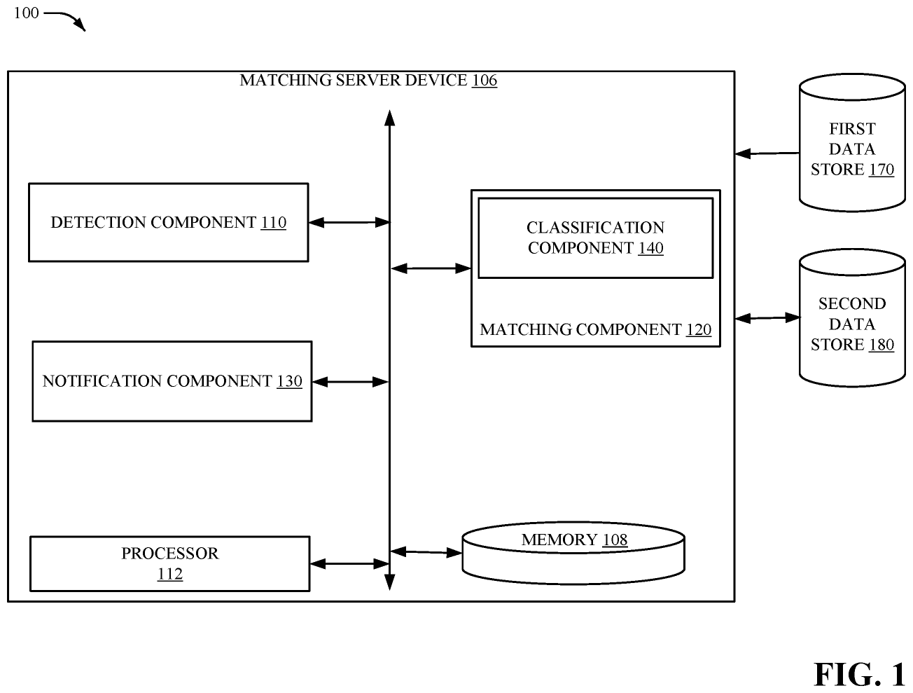

FIG. 1 illustrates a block diagram of an example, non-limiting system 100 that can facilitate a detection of lead data in accordance with one or more embodiments described herein. In an aspect, system 100 can include matching server device 106 that can employ memory 108, processor 112, detection component 110, matching component 120, and notification component 130 in a non-limiting embodiment. In other embodiments, each respective component can be implemented on other devices (e.g., servers, mobile devices, computing devices, etc.). In another aspect, system 100 can include first data store 170 and second data store 180 in accordance with one or more embodiments described herein. In an aspect, system 100 can include or otherwise be associated with one or more processor 112 that can execute the computer executable components and/or computer instructions stored in memory 108. In an aspect, one or more of the components of system 100 can be electrically and/or communicatively coupled to one or more devices (e.g., matching server device 106) of system 100 or other embodiments disclosed herein.

In an aspect, detection component 110 can extract (e.g., using matching server device 106) first data representing a type of candidate consumer (e.g., candidate consumer to purchase a vehicle from one automotive vendor over another) from one or more data store(s) based on lead criteria data (e.g., quantifying a significance level of a lead or likelihood of such lead to execute a target operation). For instance, lead criteria data can act as indicia to determine whether a lead is likely to browse for a vehicle (e.g., digitally and/or physically on-site), contact a vehicle vendor, purchase a vehicle, purchase particular packages from a vehicle vendor, and other such operations. In an aspect, first data can represent web-based activity data and/or non-web-based activity data corresponding to candidate automotive consumer device(s). For instance, in a non-limiting example, web-based activity data can include data input (e.g., by a candidate consumer device) through a form-fill mechanism of an automotive dealership website application executing on a user device (e.g., smartphone device, tablet device, desktop computer, etc.). In another instance, non-web-based activity data can include data representing a user (e.g., candidate automotive consumer) number of physical visits to car dealerships (e.g., represented via GPS data) or social media data representing a user input of data corresponding to a like, preference or behavior that can be determined to represent a level of interest and/or likelihood to purchase a vehicle.

In another aspect, web-based activity data can correspond to historical web-based activity. In an aspect, such first data can be extracted from one or more first data store 170 such as a data store representing a dealer customer relationship management storage device, a dealership data management system executing on a dealership device, a data store comprising social media data, a data store comprising location data (e.g., data records of visiting automotive dealer location) of user devices (e.g., smart phone or smart phone application executing on a smart phone device), or other such data stores. For instance, processor 112 can execute detection component 110 to extract first data from disparate data sources (e.g., one or more data store 170) that can represent data from one or more website application (e.g., user interactive website behavior data), lead generation data (e.g., an e-mail or input data received at a dealership website application) received at a dealership data store, and/or dealer sales (e.g., record of goods or services sold to customers) or customer data stored at a dealership data management system executing on a data store. As such, the detection (e.g., using detection component 110) of web-based activity data and/or non-web-based activity data can represent interactive behaviors corresponding to candidate consumers of vehicles.

Furthermore, in another non-limiting embodiment, detection component 100 can also detect the presence of new input data or existing relevant data within one or more first data store 170. In another aspect, system 100 can employ detection component 110 to extract from one or more data store 170 first data based on lead criteria data. In an aspect, lead criteria data can represent a set of instructions or executable code that determine a relevance of a set of data as qualifying lead data such that the relevant data referred to as first data can be extracted (e.g., using an extraction component employed by detection component 110) from one or more first data store 170. In an aspect, lead criteria data can represent a set of instructions to extract first data that correlates to an indication that a user is shopping for inventory present or readily accessible to an automotive dealership as indicated by dealership data. Furthermore, lead criteria data can represent data that correlates to an indication of a user spending behaviors that are linked to a purchase of an item a dealership possess for sale as indicated by dealership data.

In a non-limiting example for detecting candidate data, a consumer device (e.g., internet enabled device) can access an instrumented retail and/or catalog website associated with an automotive vendor device (e.g., web application executing on a server device). Furthermore, a transmission component can transmit such consumer identification data (e.g., corresponding with the consumer device), website data, and metadata (e.g., collectively candidate activity data) to a clearing house data store (e.g., one or more distributed system of server devices) that classify and/or describe (e.g., using classification component) such data as well as format such data (e.g., into a standard format) to facilitate effective and consistent querying of such data as well as distribution for presentation across one or more disparate devices. Furthermore, in an aspect, the clearing house data store can employ a matching component 120 that determines and/or assigns customer identification attributes to the candidate activity data.

In another aspect, system 100 can employ processor 112 to execute matching component 120 that determines, by matching server device 106, whether a subset of first data matches second data representing existing customer information. In an aspect, matching component 120 can determine whether extracted first data matches second data in order to determine whether first data corresponds to an existing customer record (e.g., stored in a dealership CRM system implemented on a dealership data store or stored in a dealership data management system implemented on a dealership data store). For instance, processor 112 can employ matching component 120 to compare a subset of first data to second data (e.g., historical data associated with an intake form, previous interactive website activity, browsing data, location data of interested automotive vendors, etc.) based on whether any similar identification data (e.g., name information, phone number information, address information, automotive vendor location data, etc.) is identified in first data and second data. If matching component 120 finds a comparative similarity, then matching component 120 determines the subset of first data corresponds with existing customer data (e.g., second data) and the subset of first data can be integrated with the second data or a subset of second data (e.g., existing customer profile data). In the event, matching component 120 determines a satisfactory match above a threshold level of similarity (e.g., indicative of matching customer identification information) between the first data and the second data, then the customer identification information can be assigned a flag to indicate that the activity data is associated with a user having a prior record of engagement with a vendor (e.g., OEM, vehicle dealer, etc.) rather than a candidate consumer having no prior record of engagement. For instance, a lead may represent a consumer with a greater level of interest in purchasing a vehicle from a respective dealership.

In yet another aspect, system 100 can employ processor 112 to execute notification component 130 that can trigger a transmission, by the matching server device 106, of notification data to a dealer device, the one or more first data store or a one or more second data store whether a matching event occurred between the subset of first data and the second data, wherein the one or more first data store is different than the one or more second data store. In an aspect, processor 112 can execute matching component that determines a match between a subset of first data and second data has occurred thus determining that the subset of first data belongs to an existing customer. Furthermore, processor 112 can execute notification component 130 that transmits notification data to a device (e.g., application executing on a smart phone) or data store (e.g., first data store 170 or second data store 180).

In an example non-limiting embodiment, processor 112 can execute detection component 110 which extracts a subset of first data that represents a user searching a dealer website application but does not complete any intake information. In an aspect, notification data can represent a text message, an e-mail, phone call or other digital and/or non-digital form of correspondence. For instance, notification component 130 can transmit notification data representing an e-mail to a device (e.g., dealership smart phone or server) or data store (e.g., DMS, CMS, CRM, etc.) that notifies of an occurrence of marketing activities. In yet another aspect, notification component 130 can employ marketing component to execute marketing operations (e.g., online and/or offline) corresponding to one or more candidate consumer groups (e.g., of user devices). In an aspect, such marketing operations can include marketing operations executed by a demand side platform (DSP) system (e.g., executing digital advertisement exchange operations), content delivery platform (CDP) system (e.g., executing web content delivery such as advertisement delivery via embedded server software), data management platform (DMP) system (e.g., executing machine learning algorithms to extract insights about users and used for marketing purposes), or other marketing system configured to facilitate the execution of online or offline marketing operations.

Furthermore, detection component 110 can extract another subset of first data representing a user browsing an e-commerce website application for mini-van vehicle accessories. For instance, detection component 110 can extract data from data stores that store dealership website data, third party shopping data, or any tangential or related online or offline consumer behavioral data or indicator of intent to purchase a relevant good or service. In an aspect, processor 112 can execute matching component 120 to integrate the subsets of first data and correlate them (based on identification data) as corresponding to the same user. Furthermore, matching component 120 can compare the combined subsets of first data to second data representing existing customers of an automotive dealership stored in a data management system implemented on a dealership data store and determine that the subsets of first data (e.g., newly generated online and offline data) correspond to an existing customer (e.g., user device or user account of an existing customer). For instance, offline data can include wireless access point data, offline geographic positioning data, consumer data, public record data, credit data, credit score data, predictive income data, vehicle ownership data, pre-screen offer data, and other information that is not online data. Furthermore, in an aspect, online data can include data associated with web browsing, click-through data, click stream data, cookies, mobile ad identifiers (MAIDs), e-mail account information, online registration data, online site usage data (e.g., social media usage data), transaction data, mobile app data and other such data. Accordingly, processor 112 can execute notification component 130 to transmit notification data representing the detection and identification of an existing customer having interest in shopping for a vehicle. Furthermore, notification component 130 can transmit notification data to one or more device (e.g., dealership sales personnel smart phone) or one or more data store (e.g., dealership management system data store or dealership customer relationship management system data store). In another aspect, notification component 130 can transmit notification data to one or more device or data store that represents a matching event has not occurred, such that an indication that a subset of first data does not match an existing customer data has occurred.

In an aspect, processor 112 can execute notification component 130 to transmit a subset of notification data that represents that a previous customer shopping for an item of relevance (e.g., vehicle) to a data store (e.g., CMS, CRM, DMS, etc.). Furthermore, in another aspect, processor 112 can execute notification component 130 to transmit a subset of notification data that represents that a new candidate customer or lead is shopping for an item of relevance (e.g., vehicle). For instance, first data (e.g., newly generated and evaluated online and offline data of a user device) determined to correspond to second data (e.g., intake information previously received from a candidate customer user device) can indicate that the first data corresponds to a lead or prospect as opposed to a candidate consumer. A lead can indicate a greater likelihood of executing a purchase of a vehicle as opposed to a new consumer candidate that is determined to shop for a vehicle for the first time.

In yet another non-limiting embodiment, matching component 120 can employ a classification component 140 that classifies subsets of first data into at least one of a previous customer lead data group, previous customer anonymous shopper data group, a conquest lead data group, or an anonymous conquest data group. As such, while matching component 120 can determined whether a subset of first data corresponds to existing customer data (e.g., second data), classification component 140 can determine whether the subset of first data that corresponds with existing customer data is considered a lead (e.g., user with a prior record of engagement) or not a lead (e.g., user with no prior record of engagement). In the event, classification component 140 determines the subset of first data corresponding to an existing customer to be a lead, such data is grouped with other similar first data subsets into a previous customer lead data group representing a customer that has self-identified that they are a previous customer (e.g., inputting data into fields executing on a web application).

In the event, classification component 140 determines the subset of first data corresponding to an existing customer is not a lead, such data is grouped with other similar first data subsets into a previous customer anonymous shopper data group representing a customer that has been determined (e.g., using matching component 120) as a previous customer but not via self-identification but via analysis of other data source mechanisms (e.g., the user is detected to be shopping on a website application anonymously). In the event, classification component 140 determines the subset of first data that does not correspond to an existing customer is a lead, such data is grouped with other similar first data subsets into a conquest lead data group representing a self-identified new potential customer that has not been a previous customer (e.g., no data record of such user in a dealership CRM or DMS). In the event, classification component 140 determines the subset of first data that does not correspond to an existing customer is not a lead, such data is grouped with other similar first data subsets into an anonymous conquest lead data group representing a new potential customer that has not been a previous customer (e.g., no data record of such user in a dealership CRM or DMS) and has been identified as anonymous (e.g., shopping for vehicles anonymously using a website application). In various embodiments, a determination of whether a data subset is a lead occurs based on a verification mechanism.

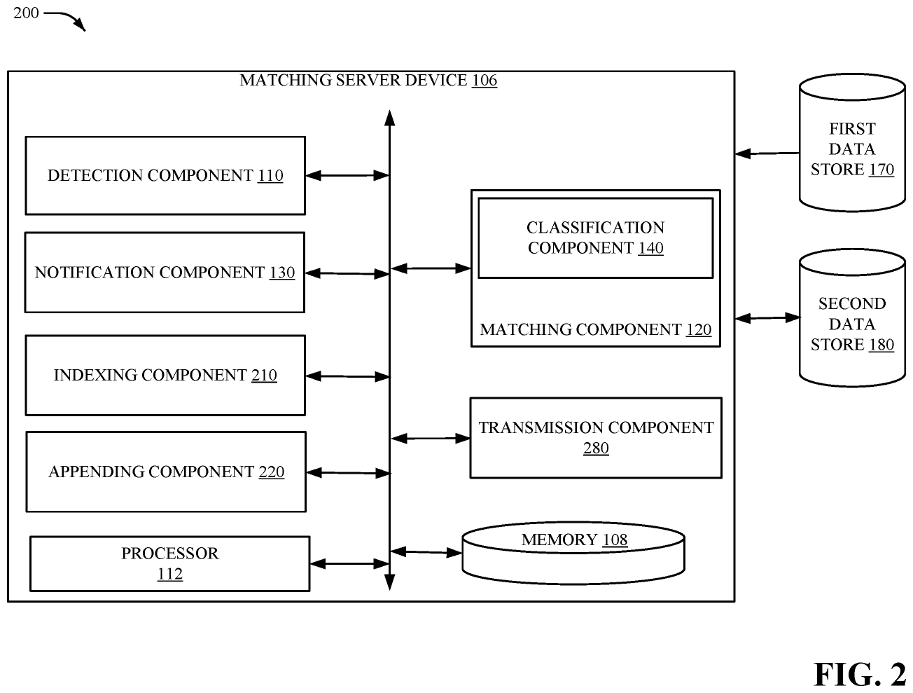

Turning now to FIG. 2, illustrated is a block diagram of an example, non-limiting system 200 that can facilitate an indexing of lead data and an enrichment of lead data with enriched data in accordance with one or more embodiments described herein. Repetitive description of like elements employed in other embodiments described herein is omitted for sake of brevity.

In an aspect, system 200 can include matching server device 106 that can employ memory 108, processor 112, detection component 110, matching component 120, and notification component 130 in a non-limiting embodiment. In other embodiments, each respective component can be implemented on other devices (e.g., servers, mobile devices, computing devices, etc.). In another aspect, system 200 can include first data store 170 and second data store 180 in accordance with one or more embodiments described herein. In an aspect, system 200 can include or otherwise be associated with one or more processor 112 that can execute the computer executable components and/or computer instructions stored in memory 108. In an aspect, one or more of the components of system 200 can be electrically and/or communicatively coupled to one or more devices (e.g., matching server device 106) of system 200 or other embodiments disclosed herein. In another aspect, system 200 can further comprise indexing component 210 that indexes, by the matching server device 106, the first data into a lead classification framework based on lead classification criteria data, wherein the lead classification framework is web-based activity data and/or non-web-based activity data. Furthermore, system 200 can further comprise appending component 220 that appends, by the matching server 106, third data to the existing customer profile or a new customer profile, wherein the third data can represent demographic information, behavioral information, click trail information, clickable link information, and other information corresponding to the existing customer profile. Also, system 200 can further comprise transmission component 280 that transmits, by the matching server, a set of data comprising at least one of the first data, the second data, the enriched first data, or the third data to one or more data store or one or more device.

In an aspect, processor 112 of system 200 can execute indexing component 120 that indexes, by the matching server device 106, the first data into a lead classification framework based on lead classification criteria data. In an aspect, first data can be extracted by detection component 110 from disparate data sources (e.g., one or more data store 170) and represent data from one or more website application (e.g., user interactive website behavior data) lead generation data (e.g., an e-mail or input data received at a dealership website application) received at a dealership data store, dealer sales, servicing, and/or customer data stored at a dealership data management system executing on a data store.

In another aspect, the extracted data can be transmitted to matching server device 106 as blocks of data (e.g., of varying sizes or data storage quantities such as gigabytes) which can be referred to as nodes. In an aspect, indexing component 120 can classify the blocks of first data based on lead classification criteria data or other data classification framework(s). In an aspect, lead classification criteria data can represent instructions that configures a data structure within matching server device 106 to store first data within various classifiers based on values associated with first data blocks. For instance, various subsets of first data can be indexed (e.g., using indexing component 120) and/or grouped based on whether subsets of first data represent user web-based activity (e.g., inputs within website application fields, anonymous browsing of a website, etc.) or non-web-based activity (e.g., social media behaviors such as liking or subscribing activities, GPS tracking data of a device belonging to a user, etc.).

Furthermore, in an aspect, processor 112 can execute appending component 220 that appends, by the matching server 106, third data to the subset of first data, wherein the third data represents demographic information or behavioral information corresponding to the existing candidate customer profile. In an aspect, third data can include demographic data, customer preference data, customer behavioral data, consumer purchase data, or other such data that indicates a quality of a candidate lead. In an aspect, subsequent to the subset of first data being enriched by third data, the enriched subset of first data can be transmitted (e.g., by system 200 transmission components 280) to a data store (e.g., dealer CRM, dealer DMS, matching server device 106, lead management systems, client marketing system, etc.) or device (e.g., dealer smartphone). In some non-limiting embodiments, system 100 and system 200 can employ a parsing component (not illustrated) that receives first data or enriched first data and parses such first data such that the parsed data can be formatted and compiled by other data stores or devices. In another non-limiting embodiment, processor 112 can execute appending component 220 to append third data to fourth data imported from other data stores (e.g., dealership DMS, dealership CRM, lead management systems, customer marketing systems, etc.). In other non-limiting embodiments, system 100 and system 200 can employ monitoring components that monitor e-mail data for compliance with technical rules. In another aspect, first data can be parsed using parsing component such that all first data and fourth data can be appended with enrichment data and such enriched data can be transmitted to a data store.

In another aspect, in system 100 and system 200, upon enriched data first data or first data transmission to a data store (e.g., dealer CRM, CMS, lead management tool, etc.), such first data or enriched first data can be received by the data store as a duplicate subset data in the event the subset of first data is associated with existing second data within the data store. For instance, in a non-limiting embodiment, first data or enriched first data (e.g., representing an anonymous customer, an anonymous existing customer, existing customer data or any of the following data types enriched with additional data such as demographic data) can be transmitted to a dealer data store (e.g., CRM, CMS, or DMS). Furthermore, in an instance, the data store (e.g., CRM, CMS, or DMS) can receive such first data or enriched data and index such data as duplicate data (e.g., a duplicate profile of an existing customer) or as additional data to be appended to existing data (e.g., data added to an existing customer profile). Thus, such transmitted data can be stored as an entirely new lead or duplicate lead based upon a matching algorithm of the data store (e.g., CRM, CMS, or DMS).

In another instance, first data (e.g., lead data) received from a dealer website (e.g., candidate customer inputting data into a lead form) can be enriched with additional data (e.g., demographic information) such that the enriched data can be transmitted to a dealer data store. Accordingly, the enriched data can either be appended to existing customer (e.g., profile) data, be classified as new customer data, and can be classified as either new customer or existing customer via a duplication mechanism within the data store. Furthermore, in the event a duplicate data mechanism is implemented, such duplicate profile data or new profile data can store data indicating the source (e.g., lead form input data on dealer website, etc.) of the duplicate profile data or new profile data. Furthermore, even if a non-duplication mechanism is implemented, the source of the profile data can be stored within the non-duplicate profile data. As such, some data transmitted to the dealer data store may or may not be recognized as a duplicate lead and/or duplicate candidate consumer based on the matching algorithm employed by the data store or matching server device 106.

In an aspect, a user (e.g., dealership sales person) can access enriched first data or first data via the data store based on locations within structural frameworks of the data store that can accommodate such data (e.g., fields, structured data partitions, unstructured data partitions of the data store, etc.). In a non-limiting instance, in a non-limiting embodiment, enriched first data or first data can be transmitted (e.g., using a transmission component 280) to populate a comment field within a data store such that several data points (e.g., eighteen data points in a non-limiting embodiment) can be entered into an existing data store regardless of having particular frameworks or fields to compartmentalize the first data or enriched data. In another non-limiting embodiment, a secure hyperlink data representing a pointer to enriched first data or first data (e.g., represented in some instances as a profile and such links can be embedded in predefined fields of data stores such as comments fields) can be transmitted to the data store to provide access to a location having enriched first data or first data within a profile comprising a set of second data or new data identifying a never before identified lead. For instance, a hyperlink can allow (based on access credentials or permissions) for the access to a web interface that presents enriched first data or first data.

In another non-limiting embodiment, a web application executing a web interface displaying first data and/or enriched first data can comprise an administrative or lead dashboard based on relevant permission or access credentials. In an aspect, an administrative level access credential can allow for visibility of all administrative and lead candidate user profiles and provide various capabilities (e.g., add/remove access credentials to a dashboard). Furthermore, a dashboard component executed by a web application (or device application such as smartphone application) can provide various viewing formats (e.g., quick view format) by lead data. In an aspect, the system 100 and system 200 can allow for access to a set of several unique data points (e.g., first data and enriched first data) associated with a lead (anonymous or self-identified) or existing customer. In a non-limiting embodiment, over fifty unique data points can be associated with a lead or existing customer.

In a non-limiting embodiment, system 100 and/or system 200 can employ a matching and enrichment system (not illustrated in Figures) that utilizes matching component 120 and appending component 220. In an aspect, the matching and enrichment system can comprise a server device (e.g., Linux server) that stores and/or integrates candidate consumer data (e.g., detected from web-based activity and non-web-based activity), DMS data from a DMS data store (e.g., vehicle dealership DMS) such as 5-years of DMS data (pushed or pulled via a data loader to the Linux server), and/or CRM data from a CRM (e.g., vehicle dealership CRM) such as parsed lead data. Furthermore, the data (e.g., anonymous and/or self-identified data) from the Linux server device can be enriched (e.g., using appending component 220) and returned to the Linux server device. Accordingly, the enriched data can be transmitted to a matching server device that employs matching component 120. In an aspect, matching component 120 can compare and/or match the enriched anonymous and/or self-identified data to historical data (e.g., from a vehicle dealership CRM) to determine whether the data is matched to previous customer data. Furthermore, in an aspect, matching component 120 can employ threshold comparisons (e.g., comparing values associated with each subset of data to a threshold value) to determine if a lead is a previous customer lead, previous customer anonymous lead, conquest lead, or anonymous conquest.

In yet another aspect, system 100 and/or system 200 can integrate with direct mail devices such that direct mail devices can generate and transmit direct mail pieces based on an identity and qualitative requirements of one or more lead. For instance, a direct mail piece can be triggered for mailing (or generation and sale) based on receipt of subsets of first data or subsets of enriched data or notification data. As such, a marketing operation can be triggered based on the lead classification notified (e.g., using notification component 130) to various devices. Furthermore, upon transmission of one or more direct mail piece, notification component 130 can transmit notification data, representing a notice that direct mail was sent, to a data store (e.g., DMS, CRM, CMS, dealer device such as smartphone). In another aspect, notification component 130 can transmit notification data to a dealer data store (E.g., CRM, CMS, DMS, etc.) or dealer device (e.g., smart phone) that a direct mail item has been sent to a respective candidate customer. In an aspect, dealer device can represent a range of device(s) such as a user device (e.g., smartphone, tablet, etc.), server device (e.g., device that provides services to client machines in the dealer network based on requests such as queries, allows for resource sharing, manages data, etc.) such as a file server (e.g., transmits files to client machines) or database server or mail server or application server, data store (e.g., device configured to store data, access data, files and applications, etc.), database, and other such devices.

In other non-limiting implementations, marketing architectures (e.g., digital and physical marketing architectures) can be converged with system 100 and/or system 200 in order to improve targeted marketing efforts. For instance, various architectures that enable vehicle vendors to generate and aggregate consumer activity data, preference data (e.g., from online, in-store, out of store activities), video viewing data, retail location data (e.g., using GPS data, video data at store, etc.), and other data that facilitates monitoring data and tracking data generation (e.g., RFID tracking technology, smart shopping cart systems and devices, point-of-sale systems, etc.).

Furthermore, in another non-limiting embodiment, indexing component 210 can classify subsets of first data as representing a sales lead or a service lead based on a classification criterion. In another aspect, call tracking number data can correspond with a service lead classification data or sales lead classification data based upon text and/or speech analysis technologies. In an aspect, a dealership can transmit target market message data to a lead type or data store (e.g., CRM). In an aspect, system 100 and/or system 200 capability to identify anonymous new lead data and generate notification data for transmission to data stores can significantly improve current dealership data store capabilities. Furthermore, in an aspect, processor and memory access efficiencies can be created by implementation of such capabilities. In yet another aspect, the automated populating of first data and enriched first data via mechanisms (e.g., duplication technologies) can improve the efficacy of data stores (e.g., CMS, CRM, DMS, etc.). In another aspect, various embodiments and implementations can apply to a range of industries (e.g., retail, automotive, healthcare, etc.).

In an aspect, system 100 and system 200 can transmit first data or enriched first data to a data store (e.g., CMS, DMS, CRM, smart phone device, web application, etc.) and in some instances a subset of first data can represent a transmission of an anonymous shopper lead data into a data store and such anonymous shopper lead data can be matched to second data to determine whether the anonymous shopper lead data corresponds to previous customer data or previous lead data.

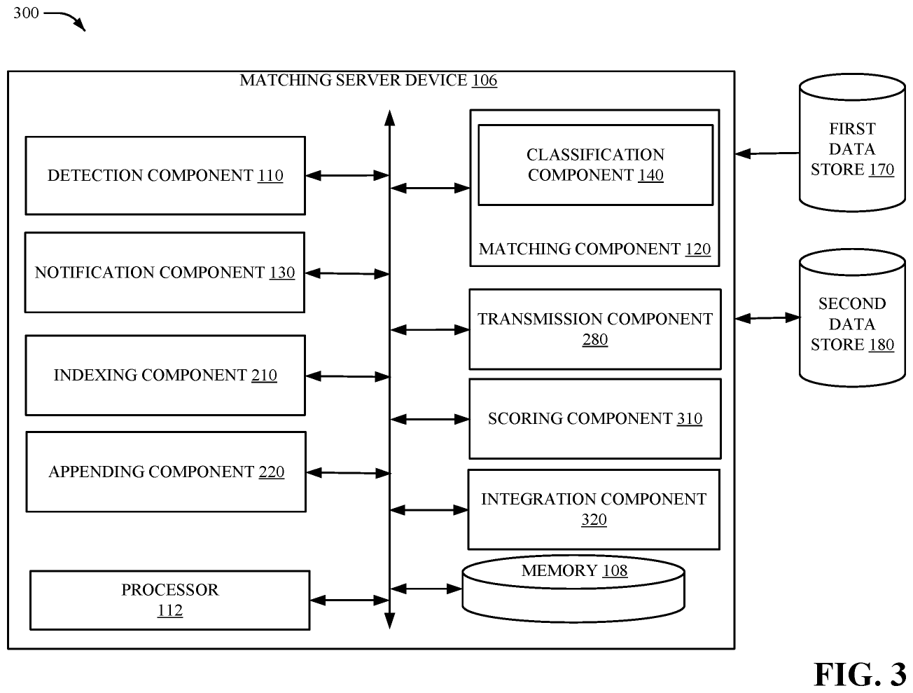

Turning now to FIG. 3, illustrated is a block diagram of an example, non-limiting system 300 that can facilitate an assigning of one or more score to lead data in accordance with one or more embodiments described herein. Repetitive description of like elements employed in other embodiments described herein is omitted for sake of brevity.

In an aspect, system 300 can include matching server device 106 that can employ memory 108, processor 112, detection component 110, matching component 120, notification component 130, indexing component 210, appending component 220, and transmission component 280 in a non-limiting embodiment. In other embodiments, each respective component can be implemented on other devices (e.g., servers, mobile devices, computing devices, etc.). In another aspect, system 300 can include first data store 170 and second data store 180 in accordance with one or more embodiments described herein. In an aspect, system 300 can include or otherwise be associated with one or more processor 112 that can execute the computer executable components and/or computer instructions stored in memory 108. In an aspect, one or more of the components of system 300 can be electrically and/or communicatively coupled to one or more devices (e.g., matching server device 106) of system 300 or other embodiments disclosed herein. In another aspect, system 300 can further comprise scoring component 310 that assigns, by the matching device 106, a score to the first data based on a set of qualification criteria that represents a candidacy of lead to make a purchase. In another aspect, system 300 can further employ processor 112 to execute an integration component 320 that integrates, by the matching server device 106, the first data into a structured data format or unstructured data format compatible with the matching server device 106.

In an aspect scoring component 310 can assign a score to subsets of first data based on a qualification of lead data that represents a quality of lead or candidacy for conversion into a sale (e.g., quality of candidate consumer). For instance, a higher score assignment to a subset of first data that is anonymous but shopping on the dealer's website may indicate a higher priority lead capable of conversion to a sale. In another aspect, integration component 320 can integrate several types of data models, named relations, attributes (e.g., floating point numbers, integers, character strings, dates, money, names, etc.), and other data qualities to allow for an integration of various data subsets from disparate sources into a single data set. Furthermore, integration component 320 can integrate several types of data to be accommodated for storage, compartmentalization, and access on matching server device 106. In an aspect, integration component 320 can integrate data based on behaviors (e.g., reaction to online advertisements), demographic information, online browsing habits, offline location information, associated with such user devices corresponding to the data, and other such attributes.

In other non-limiting embodiments, system 300 (and other systems disclosed herein) can employ machine learning components and artificial intelligence techniques that facilitate iterative and/or recurrent grouping of subsets of first data into various groups based on similarity comparisons executed by one or more processor. A human is unable to replicate such operations, which often require a subject data packet configuration and/or subject communication between processing components. Furthermore, in an aspect, machine learning components (e.g., a series of server devices and data stores and processors) can perform predictive iterative groupings for follow on subsets of first data.

In non-limiting aspects, the systems and methods disclosed herein can enhance data based on distributed architectures (e.g., one or more processors, one or more server devices, one or more user devices, one or more CRM's, one or more DMS's, etc.). As such the components disclosed herein operate in an unconventional manner to achieve an improvement in computer functionality. For instance, the components herein can be layered into various arrays that allow for the simultaneous enrichment of lead data from several data stores (e.g., DM's, CRM's) and return enriched data to any number of data stores. Furthermore, components and systems disclosed herein can be integrated with the tangible and physical marketing systems disclosed herein (e.g., direct mailing systems) to facilitate the automatic triggering of directed marketing operations. Furthermore, in an aspect, the lead classification and/or marketing operations disclosed herein cannot be performed by a human. For instance, a human cannot generate, categorize, group and enrich lead data based on sensed offline activity and online activity. Moreover, a human cannot perform the processing activities required across a distributed network of devices to generate, categorize, group and enrich lead data corresponding to numerous devices simultaneously. Furthermore, a human is unable to communicate determined and grouped lead data and/or packetized data for communication between a main processor (e.g., using processor 118) and a memory (e.g., memory 108).

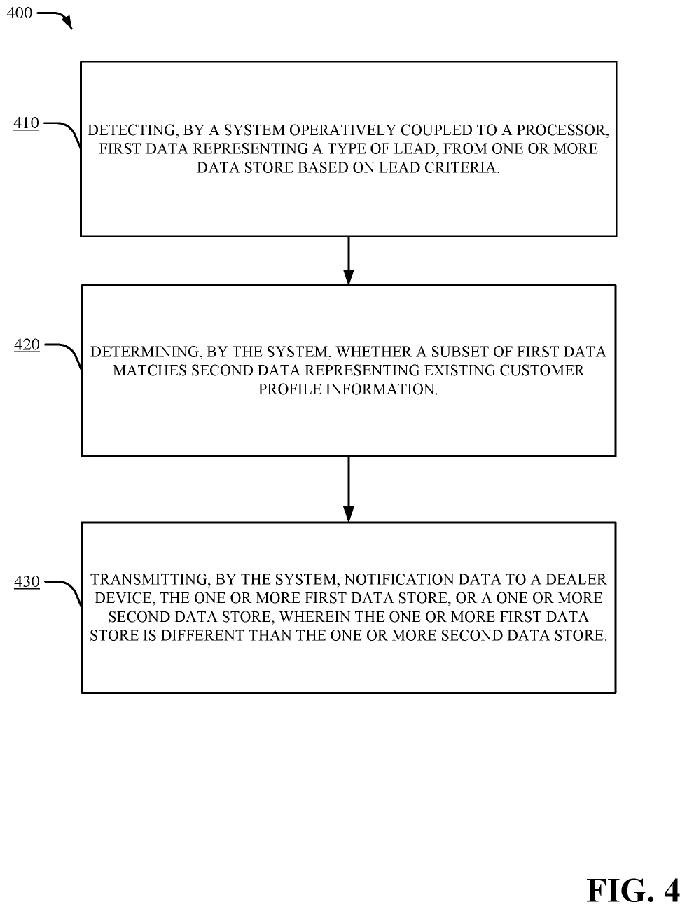

Turning now to FIG. 4, illustrated is a flow diagram of an example, non-limiting computer-implemented method 400 that can facilitate a detection of lead data in accordance with one or more embodiments described herein.

In an aspect, one or more of the components described in computer-implemented method 400 can be electrically and/or communicatively coupled to one or more devices. Repetitive description of like elements employed in other embodiments described herein is omitted for sake of brevity. In some implementations, at reference numeral 410, a system operatively coupled to a processor (e.g., processor 112) can detect (e.g., using detection component 110) first data representing a type of lead, from one or more first data store based on lead criteria data. At reference numeral 420, the system can determine (e.g., using matching component 120) whether a subset of first data matches second data representing existing customer information. At reference numeral 430, the system can transmit notification data (e.g., using notification component 130) to a dealer device, the one or more first data store or a one or more second data store based on whether a matching event occurred between the subset of first data and the second data, wherein the one or more first data store is different than the one or more second data store.

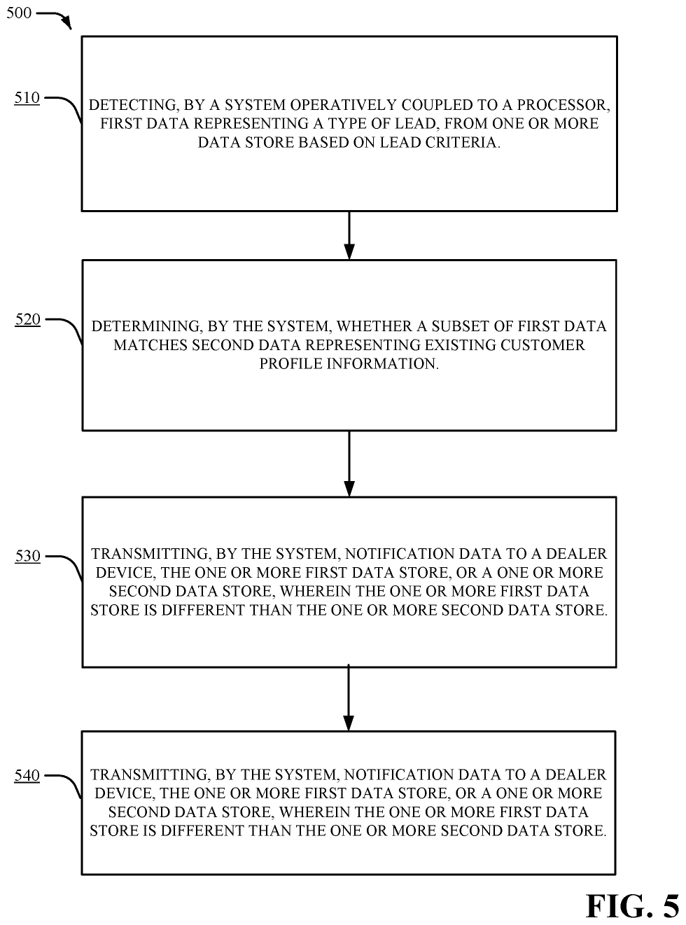

Turning now to FIG. 5, illustrated is a flow diagram of an example, non-limiting computer-implemented method 500 that can facilitate a detection of lead data in accordance with one or more embodiments described herein.

In an aspect, one or more of the components described in computer-implemented method 500 can be electrically and/or communicatively coupled to one or more devices. Repetitive description of like elements employed in other embodiments described herein is omitted for sake of brevity. In some implementations, at reference numeral 510, a system operatively coupled to a processor (e.g., processor 112) can detect (e.g., using detection component 110) first data representing a type of lead, from one or more first data store based on lead criteria data. At reference numeral 520, the system can determine (e.g., using matching component 120) whether a subset of first data matches second data representing existing customer information. At reference numeral 530, the system can transmit notification data (e.g., using notification component 130) to a dealer device, the one or more first data store or a one or more second data store based on whether a matching event occurred between the subset of first data and the second data, wherein the one or more first data store is different than the one or more second data store. At reference numeral 540, the system can append (e.g., using appending component 210) by the matching server device (e.g., using matching server device 106), third data to the subset of first data, wherein the third data appended to the first data is transformed into enriched first data, and wherein the third data represents demographic information or behavioral information corresponding to the existing customer profile.

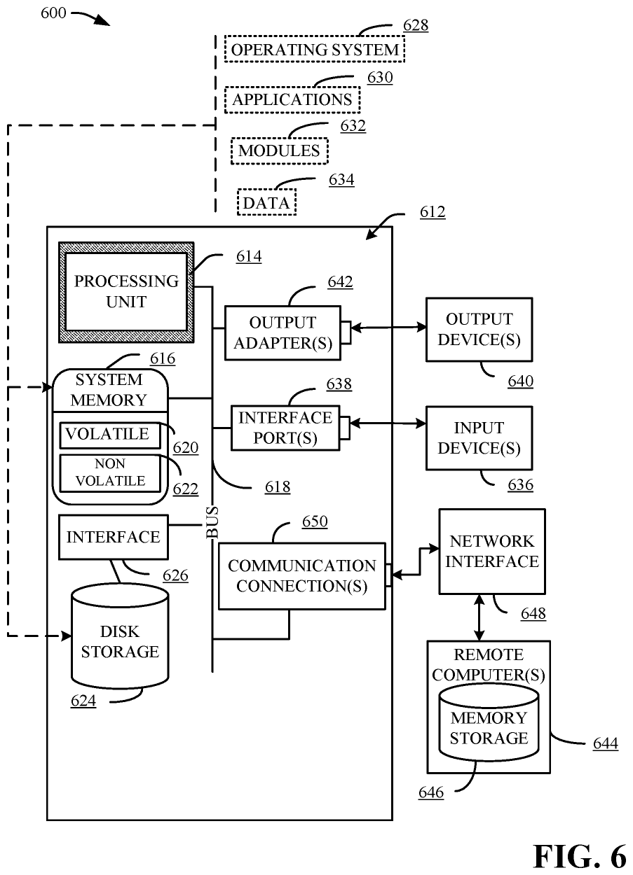

FIG. 6 illustrates a block diagram of an example, non-limiting operating environment 600 in which one or more embodiments described herein can be facilitated.

In order to provide a context for the various aspects of the disclosed subject matter, FIG. 6 as well as the following discussion is intended to provide a general description of a suitable environment in which the various aspects of the disclosed subject matter can be implemented. FIG. 6 illustrates a block diagram of an example, non-limiting operating environment in which one or more embodiments described herein can be facilitated. With reference to FIG. 6, a suitable operating environment 600 for implementing various aspects of this disclosure can also include a computer 612. The computer 612 can also include a processing unit 614, a system memory 616, and a system bus 618. The system bus 618 couples system components including, but not limited to, the system memory 616 to the processing unit 614. The processing unit 614 can be any of various available processors. Dual microprocessors and other multiprocessor architectures also can be employed as the processing unit 614. The system bus 618 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 616 can also include volatile memory 620 and nonvolatile memory 622. The basic input/output system (BIOS), containing the basic routines to transfer information between elements within the computer 612, such as during start-up, is stored in nonvolatile memory 622. By way of illustration, and not limitation, nonvolatile memory 622 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 620 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 612 can also include removable/non-removable, volatile/non-volatile computer storage media. FIG. 6 illustrates, for example, a disk storage 624. Disk storage 624 can also include, but is not limited to, devices like a magnetic disk drive, floppy disk drive, tape drive, Jaz drive, Zip drive, LS-100 drive, flash memory card, or memory stick. The disk storage 624 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 624 to the system bus 618, a removable or non-removable interface is typically used, such as interface 626. FIG. 6 also depicts software that acts as an intermediary between users and the basic computer resources described in the suitable operating environment 600. Such software can also include, for example, an operating system 628. Operating system 628, which can be stored on disk storage 624, acts to control and allocate resources of the computer 612.

System applications 630 take advantage of the management of resources by operating system 628 through program modules 632 and program data 634, e.g., stored either in system memory 616 or on disk storage 624. It is to be appreciated that this disclosure can be implemented with various operating systems or combinations of operating systems. A user enters commands or information into the computer 612 through input device(s) 636. Input devices 636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 614 through the system bus 618 via interface port(s) 638. Interface port(s) 638 include, for example, a serial port, a parallel port, a game port, and a universal serial bus (USB). Output device(s) 640 use some of the same type of ports as input device(s) 636. Thus, for example, a USB port can be used to provide input to computer 612, and to output information from computer 612 to an output device 640. Output adapter 1242 is provided to illustrate that there are some output device 640 like monitors, speakers, and printers, among other such output device 640, which require special adapters. The output adapters 642 include, by way of illustration and not limitation, video and sound cards that provide a means of connection between the output device 640 and the system bus 618. It should be noted that other devices and/or systems of devices provide both input and output capabilities such as remote computer(s) 644.

Computer 612 can operate in a networked environment using logical connections to one or more remote computers, such as remote computer(s) 644. The remote computer(s) 644 can be a computer, a server, a router, a network PC, a workstation, a microprocessor based appliance, a peer device or other common network node and the like, and typically can also include many or all of the elements described relative to computer 612. For purposes of brevity, only a memory storage device 646 is illustrated with remote computer(s) 644. Remote computer(s) 644 is logically connected to computer 612 through a network interface 648 and then physically connected via communication connection 650. Network interface 648 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 650 refers to the hardware/software employed to connect the network interface 648 to the system bus 618. While communication connection 650 is shown for illustrative clarity inside computer 612, it can also be external to computer 612. The hardware/software for connection to the network interface 648 can also include, for exemplary purposes only, internal and external technologies such as, modems including regular telephone grade modems, cable modems and DSL modems, ISDN adapters, and Ethernet cards.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes the computer executable components stored in the memory, wherein the computer executable components comprise:
a detection component that extracts, by a matching server device, first data representing a type of lead, from one or more first data store based on lead criteria data;
a matching component that determines, by the matching server device, whether a subset of first data matches second data representing existing customer information;
a notification component that transmits, by the matching server device, notification data to a dealer device, the one or more first data store or a one or more second data store based on whether a matching event occurred between the subset of first data and the second data, wherein the one or more first data store is different than the one or more second data store.

2. The system of claim 1, further comprising an indexing component that indexes, by the matching server device, the first data into a lead classification framework based on lead classification criteria data, wherein the lead classification framework is a web-based activity data and non-web-based activity data.

3. The system of claim 1, further comprising an appending component that appends, by the matching server, third data to the subset of first data, wherein the third data appended to the first data is transformed into enriched first data, and wherein the third data represents demographic information or behavioral information corresponding to the existing customer profile.

4. The system of claim 3, further comprising a transmission component that transmits, by the matching server, a set of data comprising at least one of the first data, the second data, the enriched first data, or the third data to one or more data store or one or more device.

5. The system of claim 1, further comprising a scoring component that assigns, by the matching device, a score to the first data based on a set of qualification criteria that represents a candidacy of lead to make a purchase.

6. The system of claim 1, wherein the matching component employs a classification component that classifies subsets of the first data into at least one of a previous customer lead data group, previous customer anonymous shopper data group, a conquest lead data group, or an anonymous conquest data group.

7. The system of claim 1, further comprising an integration component that integrates, by the matching server device, the first data into a structured data format or unstructured data format compatible with the matching server device.

8. A computer-implemented method, comprising:
detecting, by a system operatively coupled to a processor, first data representing a type of lead, from one or more first data store based on lead criteria data;
determining, by the system, whether a subset of first data matches second data representing existing customer information; and
transmitting, by the system, notification data to a dealer device, the one or more first data store or a one or more second data store based on whether a matching event occurred between the subset of first data and the second data, wherein the one or more first data store is different than the one or more second data store.

9. The method of claim 8, further comprising appending, by the system, third data to the subset of first data, wherein the third data appended to the first data is transformed into enriched first data, and wherein the third data represents demographic information or behavioral information corresponding to the existing customer profile.

10. The method of claim 9, further comprising transmitting, by the system, a set of data comprising at least one of the subset of first data, the second data, the enriched first data, or the third data to one or more data store or one or more device.

11. The method of claim 8, further comprising assigning, by the system, a score to the subset of first data based on a set of qualification criteria that represents a candidacy of lead to make a purchase.

12. A computer program product for facilitating a notification of one or more leads, the computer program product comprising a computer readable storage medium having program instructions embodied therewith, the program instructions executable by a processor to cause the processor to:
detect first data representing a type of lead, from one or more first data store based on lead criteria data;
determining whether a subset of first data matches second data representing existing customer information; and
transmit notification data to a dealer device, the one or more first data store or a one or more second data store based on whether a matching event occurred between the subset of first data and the second data, wherein the one or more first data store is different than the one or more second data store.

13. The computer program product of claim 12, wherein the program instructions are further executable by the processor to cause the processor to:
trigger an occurrence of a physical marketing operation based on a receipt of the notification data.

14. The computer program product of claim 12, wherein the program instructions are further executable by the processor to cause the processor to:
assign flag data to the first data based on a determination of whether the first data is classified within a previous customer lead data group, previous customer anonymous shopper data group, a conquest lead data group, or an anonymous conquest data group.
